(19) United States
(12) Patent Application Publication
(10) Pub. No.: US 2016/0305135 A1
(43) Pub. Date: Oct. 20, 2016

(54) Window Installation Stand

(71) Applicant: Bobby J. Hollis, Southside, TN (US)

(72) Inventor: Bobby J. Hollis, Southside, TN (US)

(21) Appl. No.: 15/098,771

(22) Filed: Apr. 14, 2016

Related U.S. Application Data
(60) Provisional application No. 62/147,050, filed on Apr. 14, 2015.

(51) Int. Cl. E04G 3/18; E06B 1/56

(52) U.S. Cl. CPC E04G 3/18; E06B 1/56

(57) ABSTRACT

A window stand system for supporting a worker outside a window opening of a building. The system includes a plurality of stand support components each having a hook portion dimensioned and configured to secure the stand support component to a windowsill, a vertical support member disposed adjacent the hook portion and dimensioned and configured to extend below the windowsill adjacent an outside surface of the building, and a platform receiving member extending substantially perpendicular from the vertical support member. When each of the plurality of stand support components are secured to a windowsill, the platform receiving members of the plurality of stand support components are operable to receive a platform for supporting the worker outside the window opening.

### CROSS-REFERENCE TO RELATED APPLICATION

This application claims priority to co-pending U.S. Provisional Application Ser. No. 62/147,050 filed Apr. 14, 2015, entitled “Window Installation Stand,” the entire contents of which is incorporated herein in its entirety.

### FIELD

This disclosure relates to the field of window installation. More particularly, this disclosure relates to a stand that allows a window installer to safely and easily install a window into a window frame that is high above the ground.

### BACKGROUND

To mount a pre-hung window into the opening of house or building, an installer must generally (1) place the window into the opening, (2) adjust the window so that it is level and plumb, and (3) secure the window to the opening by driving nails or screws into the window casing. Each of these steps is typically performed from outside the window, particularly the step of securing the window to the opening. Thus, installing a window often requires the installer to use a ladder or mechanical lift to access the outside of the window opening, particularly when installing windows in tall buildings. This is often times dangerous for the installer, particularly when using a ladder. Further, it makes installing windows more costly and time consuming.

What is needed therefore is a tool allowing a person to quickly and safely install windows.

### SUMMARY

The present disclosure provides a window stand system for supporting a worker outside a window opening of a building. The system includes a plurality of stand support components each having a hook portion dimensioned and configured to secure the stand support component to a windowsill, a vertical support member disposed adjacent the hook portion and dimensioned and configured to extend below the windowsill adjacent an outside surface of the building, and a platform receiving member extending substantially perpendicular from the vertical support member. When each of the plurality of stand support components are secured to a windowsill, the platform receiving members of the plurality of stand support components are operable to receive a platform for supporting the worker outside the window opening.

According to certain embodiments, each stand support component further includes a diagonal support member extending from a bottom of the platform receiving member to the vertical support member; the hook portion and vertical support member together form a candy-cane shape; a top portion of the hook portion is operable to telescopically extend and collapse to hook over windowsills having varying widths; the system further includes a platform dimensioned and configured to be passed through the window opening and laid across the platform receiving members of the plurality of stand support components secured to a windowsill; each of the plurality of stand support components further include a vertical hand rail member extending up from a distal end of the platform receiving member when the stand support component is secured to the windowsill; the system further includes a horizontal support system operable to be secured between the vertical hand rail members of adjacent stand support components or a net is secured to the vertical hand rail members of the stand support components; each of the plurality of stand support components further include a first space filling member disposed adjacent an end of the hook portion intended to be hooked underneath the windowsill inside the building and a second space filling member disposed adjacent the distal end of the vertical support member to provide cushioned contact points between the stand support component and surfaces of the building; the system further includes a platform height extender have a first vertical leg operable to be secured adjacent a proximal end of the platform receiving member and a second vertical leg operable to be secured adjacent a distal end of the platform receiving member, the platform height extender further including a second platform receiving member disposed between the first and second legs; and/or the system further includes a height adjusting member telescopically connected to a distal end of the platform receiving member and a leveling mount attached to a lower end of the height adjusting member, the leveling mount operable to adjust to different pitches of a roof of the building outside the window.

According to another embodiment of the disclosure, a method is provided for installing a pre-hung window to a building wall including: placing the pre-hung window into an appropriate open space in the building wall; moving the pre-hung window to the open position; providing a first and second stand support component, each stand support component including a hook portion dimensioned and configured to secure the stand support component to a windowsill of the pre-hung window, a vertical support member disposed adjacent the hook portion and dimensioned and configured to extend below the windowsill adjacent an outside surface of the building, and a platform receiving member extending substantially perpendicular from the vertical support member; passing the first stand support component through the window opening and securing the hook portion of the first stand support component to a first area of the windowsill; passing the second stand support component through the window opening and securing the hook portion of the second stand support component to a second area of the windowsill such that the platform receiving member of the first stand support component is aligned with the platform receiving member of the second stand support component; passing a stand platform through the window opening and placed on top of the platform receiving members of the first and second stand support components; and standing on the stand platform to finish installing the pre-hung window to the building wall.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 is a perspective view of a window stand support component according to one embodiment of the disclosure;

FIG. 2 is a perspective view from outside of a building of two stand support components secured to a windowsill with a stand platform disposed on the stand support components according to one embodiment of the disclosure;

FIG. 3 is a perspective view from inside a building of two stand support components secured to a windowsill with a stand platform disposed on the stand support components according to one embodiment of the disclosure;

FIG. 4 is a perspective view from outside of a building of a window installer standing on a window installation stand system according to one embodiment of the disclosure;

FIG. 5 is a perspective view of a window stand support component with a platform height extender according to one embodiment of the disclosure; and

FIG. 6 is a perspective view from outside a building of a stand support component secured to a windowsill according to an alternate embodiment of the disclosure.

### DETAILED DESCRIPTION

The present disclosure provides a window installation stand system that can be quickly secured to a windowsill from inside a building to allow a window installer to safely stand outside a window opening when installing a window. For purposes of the present disclosure, the term “window” refers to a moveable framework containing a typically transparent material used to close an open space in a wall or roof of a building. The phrase “window opening” refers to the window when the moveable framework is in an open position such that a window installer is able to access the outside of the building through the window. The term “windowsill” refers to a stationary, typically horizontal, bottom portion, of the window framework. As described below, the stand system generally includes two or more stand support components operable to be secured to a windowsill. Once two or more components are secured to the windowsill, the stand support components are operable to receive a stand platform passed through the window opening to complete the window installation stand system. Once the stand system is completed, the window installer can pass through the window opening and physically stand on the platform and complete installation of the window from outside the building. While the stand system is described herein as being used for installing windows, it should be understood that the stand system could be used for a number of other purposes, particularly where work is done to the exterior of a building in proximity to a window such as painting exterior portions of the building, cleaning gutters, etc.

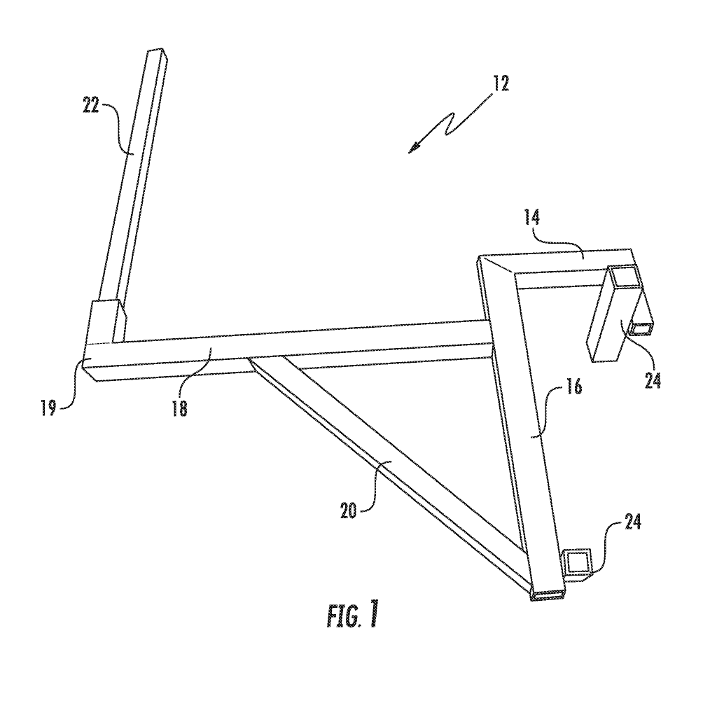

Referring to FIGS. 1, each stand support component 12 includes a hook portion 14 for securing the stand component 12 to a portion of a windowsill, a vertical support member 16 that extends from a distal end of the hook portion 14 down along an outside surface of a building wall when the stand component 12 is secured to a windowsill (it is noted that vertical support member 16 is often just an extension of the hook portion 14 further down on the side intended to be hooked to the outside of a windowsill as compared to the side of hook portion 14 intended to be hooked to the inside of the windowsill such that hook portion 14 and vertical support member 16 form a “candy-cane” shape), and a platform receiving member 18 extending substantially perpendicular from the vertical support member 16. According to preferred embodiments, each stand component 12 further includes a diagonal support member 20 extending from the bottom of the platform receiving member 18 to the vertical support member 16 to provide additional support for a stand platform placed on top of the platform receiving member 18 as described below. While the hook portion 14, vertical support member 16, platform receiving member 18, and diagonal support member 20 of stand component 12 may all be formed together in a permanent manner (e.g., welding or brazing) from high strength to weight ratio materials as known in the art, the stand component 12 preferably includes one or more removable or telescoping parts to enhance positioning of the stand component with respect to a window, portability, and storing of the components. In particular, hook portion 14 in certain embodiments is operable to telescopically extend based on varying widths of the windowsill to which the hook portion is intended to be secured.

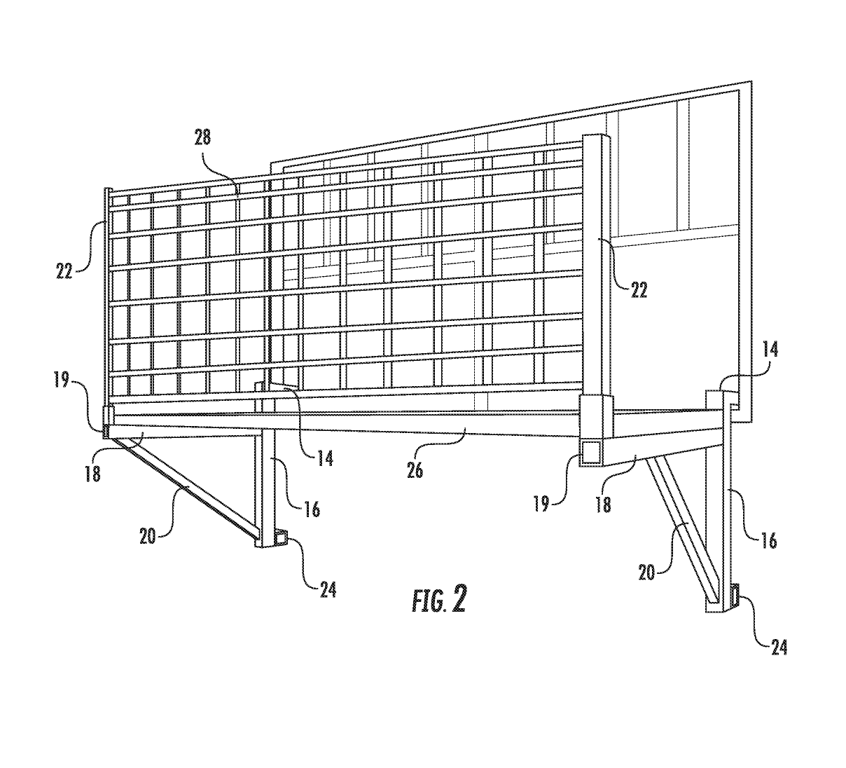

According to certain embodiments, each stand component 12 further includes a vertical hand rail member 22 extending upward from a distal end 19 of the platform receiving member 18. While vertical rail member 22 may take many forms, its objective is to help prevent window installers from falling off the sides or rear of the window installation stand system. In its simplest embodiment, vertical rail members 22 of each stand component are simply configured to warn an installer if they are getting close to the sides or rear edges of the stand by providing points of contact when the installer gets close to the side or edge of the stand. However, in preferred embodiments and as shown best in FIG. 2, a netting 28 or similar type of horizontal support system (hand rails, fencing, etc.) is disposed between adjacent rail members 22 to stop installers before they would fall off the stand. Additionally, in preferred embodiments, the vertical rail members 22 are operable to be removably secured to the distal ends of the platform receiving members 18 to make it easier to pass the stand components 12 through a window opening as well as make possible more rail system configurations. For example, in embodiments where a net is disposed between adjacent rail members 22 as shown in FIG. 2, the netting 28 can be permanently secured to the rail members 22, passed through the window opening by bundling the rail members 22 and netting 28 together, and then extended to complete the rail system by securing the rail members 22 to their appropriate platform receiving members 18. Alternately, vertical rail members 22 are permanently secured to platform receiving members, but are operable to telescopically extend to a use position and then collapse back to a storage position.

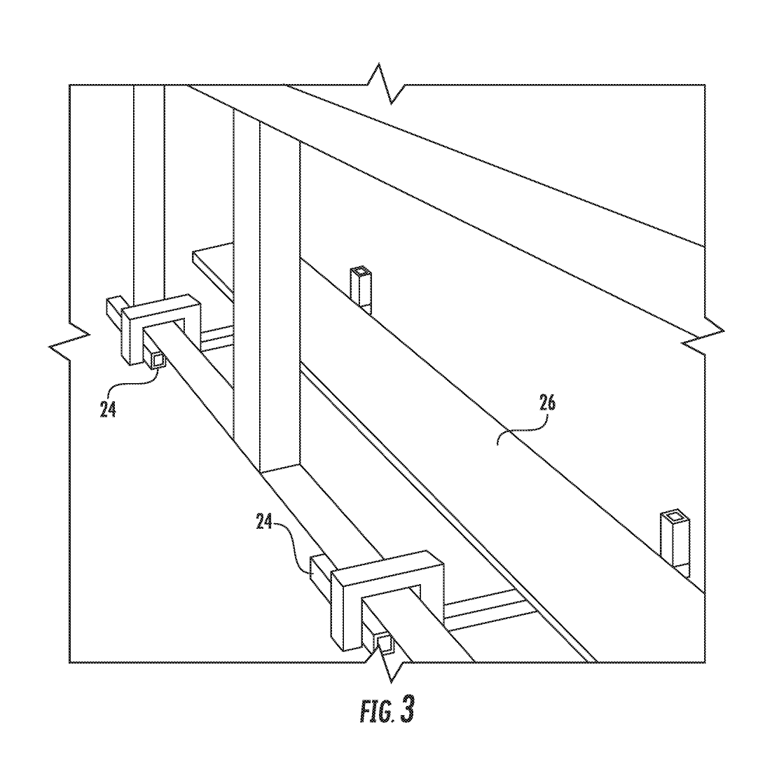

In another aspect of the disclosure, one or more space filling members 24 may be provided to provide contact points between the stand support components 12 and the inside/outside surfaces of the building. As shown in FIG. 1, in preferred embodiments, each stand support component 12 preferably includes a first space filling member 24a disposed adjacent the side of hook portion 14 intended to be hooked underneath the inside of the windowsill and a second space filling member 24b disposed adjacent the bottom end of vertical support member 16. Referring to FIG. 2, space filling members 24b provide a contact point between the stand support components 12 and the outside surface of a building wall underneath the window opening. Referring to FIG. 3, space filling members 24a provide a similar contact point between the stand support components 12 and the inside surface of the building wall directly underneath the windowsill. In preferred embodiments, space filling members 24 are formed of an expanded polymer foam or similar material as known in the art such as polystyrene, polyurethane, or polyethylene to prevent damage at the contact points between the stand support components 12 and the inside/outside surfaces of the building (i.e., “cushioned” contact points). Additionally, space filling members 24 may be removable to customize the stand support components 12 to particular window configurations. For example, in situations where the windowsill extends more significantly away from the inside surface/wall of the building directly underneath the window, space filling member 24a having a smaller width may be replaced with a space filling member 24a having a greater width.

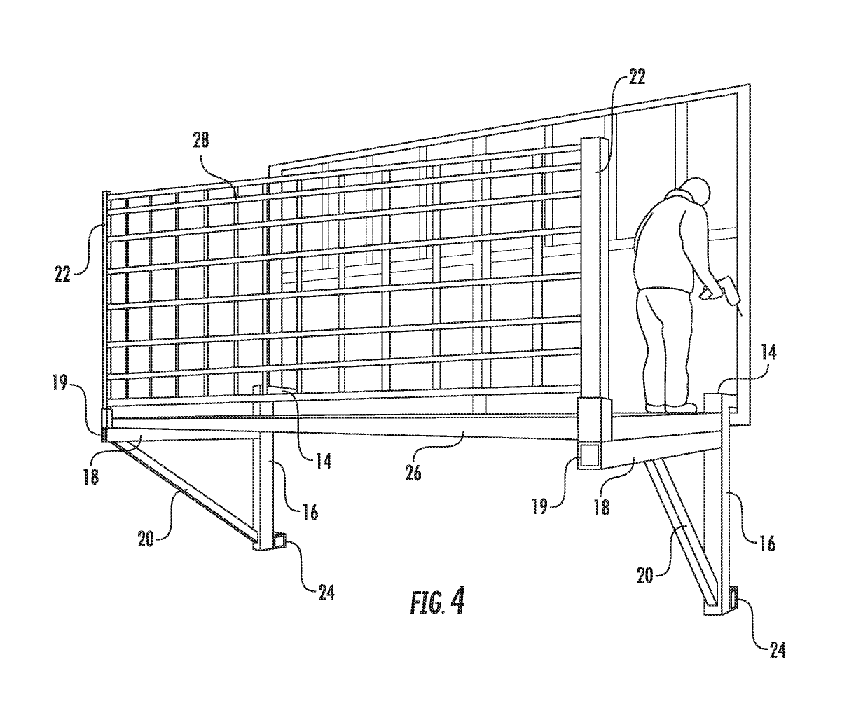

With reference to FIGS. 2-4, a typical procedure is depicted to install a window using the window installation stand system of the present disclosure. First, from inside the building, a pre-hung window is placed into the appropriate open space in a building wall. The installer makes sure the window is plumb with the opening. The installer next moves the moveable framework of the window to the open position (e.g., raises the bottom window sash) and, preferably, reaches out the window opening from inside the building to nail the sides of the window to the building with a few preliminary nails. Two or more stand components 12 are then passed through the window opening and, using hook portions 14, secured to the windowsill from inside the building. As shown in FIGS. 2-3, the vertical support members 16 extend vertically along the exterior side of the building and the platform receiving members 18 extend horizontally from the side of the building when the stand components 12 are secured to the windowsill.

After the stand components 12 are secured to the windowsill, a stand platform 26 is passed through the window opening and placed across the platform receiving members 18 as shown in FIG. 3. If used, the vertical rail members 22 are also secured to the distal end 19 of the platform receiving members 18. The installer then moves through the window opening and stands on the stand platform to finish nailing or screwing the window to the window casing of the building. Finally, the stand platform 22 and stand components 12 are brought back through the window opening to the inside of the building and the process is repeated for each window needing to be installed.

It should be understood that the stand platform 26 may take various forms and constructions. In its simplest form, stand platform 26 could simply be a 2×4 piece of wood stretched across the platform receiving members 18. In other embodiments, the stand platform is constructed of more advanced materials and may also be operable to be removably secured to the platform receiving members 18. For example, the stand platform 26 in certain embodiments includes apertures and the platform receiving members 18 include appropriately placed recesses for screwing the stand platform 26 to the platform receiving members 18.

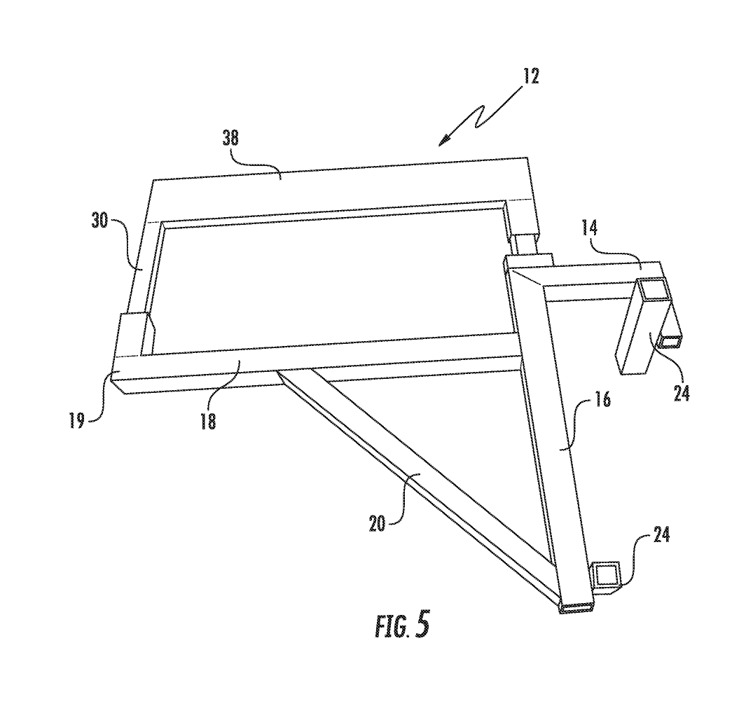

Referring to FIG. 5, a height adjustable version of the stand component of FIG. 1 is provided. According to this embodiment, the distal end 19 of platform receiving member 18 preferably includes an aperture for receiving either a vertical rail member 22 (as described above) or one leg of an optional platform height extender 30. The top of vertical member 16 or top of hook portion 14 also includes an aperture for receiving the other leg of the platform height extender 30. The platform height extender 30 further includes a second platform receiving member 38 extending between the legs of the height extender 30. Thus, when each stand component 12 includes a platform height extender 30, the stand platform 26 may be placed across the second platform receiving members 38 at height above the original platform receiving members 18.

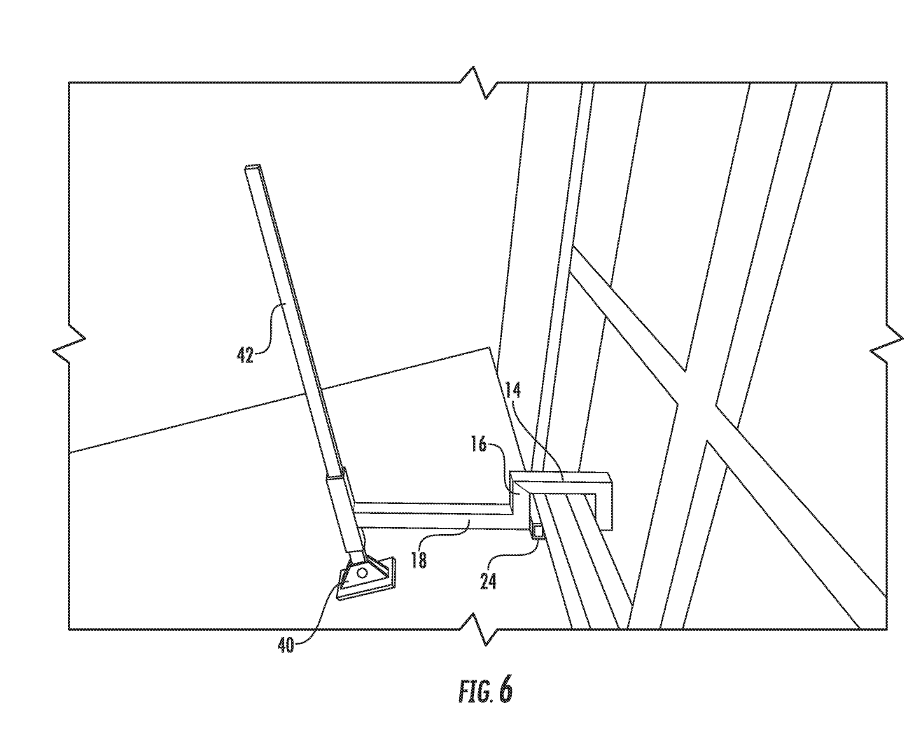

Referring to FIG. 6, an alternate embodiment of the disclosure is provided for situations where the window is installed just above a roof. According to this embodiment, the stand component includes a leveling mount or swivel foot 40 to adjust to different pitches of the roof. A height adjusting member 42 extends up from the leveling mount 40 and is connected to the distal end of platform receiving member 18. In preferred embodiments, the distal end of platform receiving member includes a receiver and the height adjusting member 42 is operable to slide within the receiver to adjust the height of the leveling mount 40 based on the space between the roof and the platform receiving member 18.

The foregoing descriptions of embodiments have been presented for purposes of illustration and exposition. They are not intended to be exhaustive or to limit the embodiments to the precise forms disclosed. Obvious modifications or variations are possible in light of the above teachings. The embodiments are chosen and described in an effort to provide the best illustrations of principles and practical applications, and to thereby enable one of ordinary skill in the art to utilize the various embodiments as described and with various modifications as are suited to the particular use contemplated. All such modifications and variations are within the scope of the appended claims when interpreted in accordance with the breadth to which they are fairly, legally, and equitably entitled.

1. A window stand system for supporting a worker outside a window opening of a building, the window stand system comprising a plurality of stand support components, each stand support component including:
a hook portion dimensioned and configured to secure the stand support component to a windowsill;
a vertical support member disposed adjacent the hook portion and dimensioned and configured to extend below the windowsill adjacent an outside surface of the building; and
a platform receiving member extending substantially perpendicular from the vertical support member,
wherein, when each of the plurality of stand support components are secured to a windowsill, the platform receiving members of the plurality of stand support components are operable to receive a platform for supporting the worker outside the window opening.

2. The window stand system of claim 1 wherein each stand support component further includes a diagonal support member extending from a bottom of the platform receiving member to the vertical support member.

3. The window stand system of claim 1 wherein the hook portion and vertical support member together form a candy-cane shape.

4. The window stand system of claim 1 wherein a top portion of the hook portion is operable to telescopically extend and collapse to hook over windowsills having varying widths.

5. The window stand system of claim 1 further comprising a platform dimensioned and configured to be passed through the window opening and laid across the platform receiving members of the plurality of stand support components secured to a windowsill.

6. The window stand system of claim 1 wherein each of the plurality of stand support components further include a vertical hand rail member extending up from a distal end of the platform receiving member when the stand support component is secured to the windowsill.

7. The window stand system of claim 6 further comprising a horizontal support system operable to be secured between the vertical hand rail members of adjacent stand support components.

8. The window stand system of claim 6 further comprising a net secured to the vertical hand rail members of the stand support components.

9. The window stand system of claim 1 wherein each of the plurality of stand support components further include a first space filling member disposed adjacent an end of the hook portion intended to be hooked underneath the windowsill inside the building and a second space filling member disposed adjacent the distal end of the vertical support member to provide cushioned contact points between the stand support component and surfaces of the building.

10. The window stand system of claim 1 further comprising a platform height extender have a first vertical leg operable to be secured adjacent a proximal end of the platform receiving member and a second vertical leg operable to be secured adjacent a distal end of the platform receiving member, the platform height extender further including a second platform receiving member disposed between the first and second legs.

11. The window stand system of claim 1 further comprising a height adjusting member telescopically connected to a distal end of the platform receiving member and a leveling mount attached to a lower end of the height adjusting member, the leveling mount operable to adjust to different pitches of a roof of the building outside the window.

12. A method of installing a pre-hung window to a building wall, the method comprising:
placing the pre-hung window into an appropriate open space in the building wall;
moving the pre-hung window to the open position;
providing a first and second stand support component, each stand support component including:
a hook portion dimensioned and configured to secure the stand support component to a windowsill of the pre-hung window,
a vertical support member disposed adjacent the hook portion and dimensioned and configured to extend below the windowsill adjacent an outside surface of the building, and
a platform receiving member extending substantially perpendicular from the vertical support member;
passing the first stand support component through the window opening and securing the hook portion of the first stand support component to a first area of the windowsill;
passing the second stand support component through the window opening and securing the hook portion of the second stand support component to a second area of the windowsill such that the platform receiving member of the first stand support component is aligned with the platform receiving member of the second stand support component;
passing a stand platform through the window opening and placed on top of the platform receiving members of the first and second stand support components; and
standing on the stand platform to finish installing the pre-hung window to the building wall.

13. The method of claim 12 wherein the first and second stand support components further include a diagonal support member extending from a bottom of the platform receiving member to the vertical support member.

14. The method of claim 12 further comprising connecting vertical hand rail members to a distal end of the platform receiving member of the first and second stand support components to install a hand rail system.

15. The method of claim 12 wherein the first and second stand support components further include a first space filling member disposed adjacent an end of the hook portion intended to be hooked underneath the windowsill inside the building and a second space filling member disposed adjacent the distal end of the vertical support member to provide cushioned contact points between the stand support component and surfaces of the building.
